(19) United States
(12) Patent Application Publication
(10) Pub. No.: US 2007/0170101 A1
(43) Pub. Date: Jul. 26, 2007

(54) Filter having anti-drainback valve and bypass valve

(76) Inventors: Kent C. Stanhope, Albion, IL (US); Kris Stanhope, Browns, IL (US); John A. Ivy, Olney, IL (US)

Correspondence Address: OLSON & HIERL, LTD., 20 NORTH WACKER DRIVE, 36TH FLOOR, CHICAGO, IL, 60606, US

(21) Appl. No.: 11/340,117

(22) Filed: Jan. 26, 2006

(51) Int. Cl. B01D 35/14

(52) U.S. Cl. 210/130; 210/429; 210/420; 210/443; 210/450

(57) ABSTRACT

A filter assembly has a housing open at one end, with an annular filter media/core assembly disposed in the housing. An end plate having at least one inlet opening and an outlet opening closes the open end of the housing. A spring having at least one bypass opening is disposed between the end of the filter media/core assembly to bias the annular filter media/core assembly towards the end plate. The end plate is affixed to a lid which is secured to the end of the housing. A first valve or anti-drainback valve cooperating with the inlet opening is retained between the filter media/core assembly and the end plate. A second valve or bypass valve cooperating with the bypass opening is retained between the filter media/core assembly and the spring. In operation, fluid will pass through the inlet opening, the filter media/core assembly and be discharged from the housing through the outlet opening. When the filter media begins to clog, pressure will build and upon attainment of a predetermined pressure the second valve will open the bypass opening and fluid flow can pass through the bypass opening to the outlet opening, for discharge from the filter assembly and return to the engine, thereby bypassing the filter media. Alternately, the spring may be a retainer member and the biasing forces to maintain the components engaged in sealing relationship are provided by the resiliency of the first and second valves.

### A. FIELD OF THE INVENTION

This invention pertains to a fluid filter assembly having a filter housing with first valve disposed between an annular filter media/core assembly and an end plate at one end of the filter housing and a second valve disposed between the annular filter media/core assembly and a spring at the second end of the filter housing.

### B. DESCRIPTION OF RELATED ART

Prior art filter devices such as that described in United States Patent Application Publication US 2005-0103692 describe a filter housing with an annular filter media/core assembly disposed therein. The filter described therein contains a combination valve with a first portion that permits fluid flow through a first inlet opening, the filter media/core assembly, and then is discharged through the outlet opening. When the filter media/core assembly begins to clog, pressure upstream builds until a predetermined pressure is attained, opening a second portion of the valve that permits fluid flow directly out a second bypass opening and out the outlet opening, bypassing the filter media/core assembly.

Some valve filters in the prior art accomplish the function of the inlet valve and bypass valve using two separate valves. These valve filters require several component parts to accomplish the anti-drainback and bypass functions and are complicated. The present invention improves on this and other deficiencies as described herein.

### C. SUMMARY OF THE INVENTION

An object of the present invention is to provide an improved filter assembly with a simpler design and a less complex bypass valve. In addition to reducing inventory of valve component parts, the bypass valve element of the present invention can be used more universally in a variety of different filter diameters.

The invention pertains to a fluid filter assembly having a cup shaped filter housing open at one end, with an annular filter media/core assembly disposed in the housing. An end plate including an inlet opening and an outlet opening is secured to and closes the open end of the housing. A first valve is disposed between the one end of annular filter media/core assembly and the end plate for controlling fluid flow through the inlet opening. A spring with a bypass opening is disposed between the other end of the annular filter media/core assembly and the top of the housing for biasing the annular filter media/core assembly towards the end plate. A second valve, which is disposed between the annular filter media/core assembly and the spring, controls fluid flow through the bypass opening in the spring. The second valve further has a higher resistance to fluid flow than the first valve.

In normal operation, the first valve yields and permits fluid flow through the inlet opening, the annular filter media/core assembly, and is discharged through the outlet opening. As the filter media/core assembly begins to clog, fluid pressure builds. When a predetermined fluid pressure is attained, the second valve opens to permit fluid flow through the bypass opening, bypassing the annular filter media/core assembly and out the outlet opening.

### D. BRIEF DESCRIPTION OF THE DRAWINGS

There is shown in the attached drawings a presently preferred embodiment of the present invention wherein like numerals in the various views refer to like elements and wherein:

FIG. 1 is a side view of the filter assembly of the present invention, with part of the filter housing cut away to show interior parts including the first valve and the second valve;

FIG. 2 is a bottom view of the filter assembly of FIG. 1;

FIG. 3 is a cross-sectional view of the end plate and lid assembly;

FIG. 4 is a cross-sectional view of the first valve;

FIG. 5 is a top view of the first valve of FIG. 4;

FIG. 6 is a top view of the spring;

FIG. 7 is a cross-sectional view of the spring of FIG. 6 taken generally along the line 7-7;

FIG. 8 is a cross-sectional view of the second valve;

### E. DETAILED DESCRIPTION OF THE INVENTION

There is shown in FIG. 1 a filter assembly embodying the present invention. The filter assembly 10 includes a generally cylindrical shell or housing 12 that is generally cup shaped and open on one end and closed on the other. Recesses or flutes 13 may be provided in the surface of the housing 12 proximate the closed end. The flutes 13 will provide a gripping surface to enhance installation of a filter assembly 10 on an engine (not shown). Disposed within the housing 12 is an annular filter media 14 that is mounted on a core 16. The annular filter media 14 and the core 16, together with end caps 64 and 66 described below, form the annular filter media/core assembly. The filter media 14 may be a conventional pleated filter media comprised, for example, of cellulose with some polyester. The filter media 14 may be formed from a sheet of pleated material joined along the facing ends by a suitable adhesive to form an annular sleeve on the core 16. The top and bottom of the filter media 14 are secured to the end caps 64, 66 by a plastisol adhesive material 52,54. The end caps 64,66 may be fabricated from a metal, for example, thin steel.

An end plate 18 is secured to the housing 12 and closes the open end of housing 12. The end plate 18 has inlet opening means 20 for permitting fluid flow into filter assembly 10 and outlet opening means 22 for permitting fluid flow out of the filter assembly 10. The inlet opening means 20 comprises one or more discrete openings. In like fashion, the outlet opening means may comprise one or more discrete openings. The inlet opening means are preferably a plurality of discrete openings arranged concentrically about a central axis of the filter (or concentrically arranged about the outlet opening). A lid 23 is secured to end plate 18. An annular resilient gasket 25 is received and retained in a recess in lid 23 for providing a seal between the filter assembly 10 and the engine block (not shown) to which the filter assembly 10 is secured in normal use.

Disposed near the open end of housing 12 between the annular filter media 14 and the end plate 18 is an anti-drainback or first valve 24. First valve 24, which is generally annular and is fabricated from a synthetic rubber material, for example, butadiene rubber, is disposed to control fluid flow through inlet opening means 20 to the annular filter media 14. The first valve 24 has an opening 29 adapted to receive the central portion 27 of the end plate 18. On the closed end of housing 12, resilient means, such as a spring 26, is disposed between the closed end of housing 12 and the annular filter media 14. Spring 26 biases annular filter media 14 towards the end plate 18. Spring 26 further has bypass opening means 28 for permitting fluid flow to the central opening in core 16. Bypass opening means 28 comprises one or more discrete openings. In the presently preferred embodiment of the invention, the bypass opening means includes eight bypass openings 28 arranged around the center of spring 26. Persons skilled in the art will understand that the configurations and numbers of openings can be varied. Disposed between the spring 26 and the annular filter media 14 is a second valve 30. Second valve 30, which is generally annular and is fabricated from a synthetic rubber material, for example, butadiene rubber, is disposed to control fluid flow through bypass openings 28.

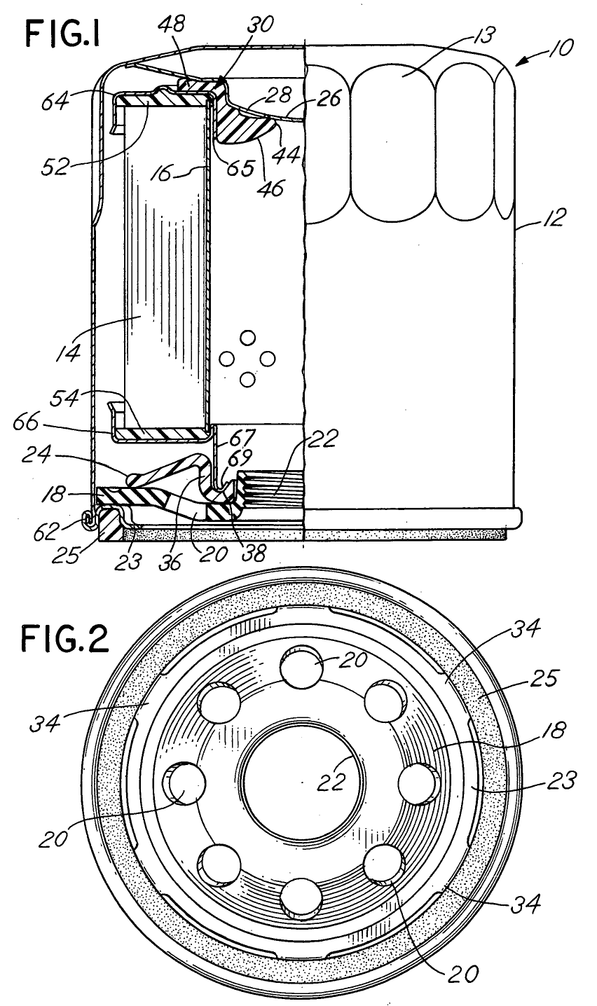

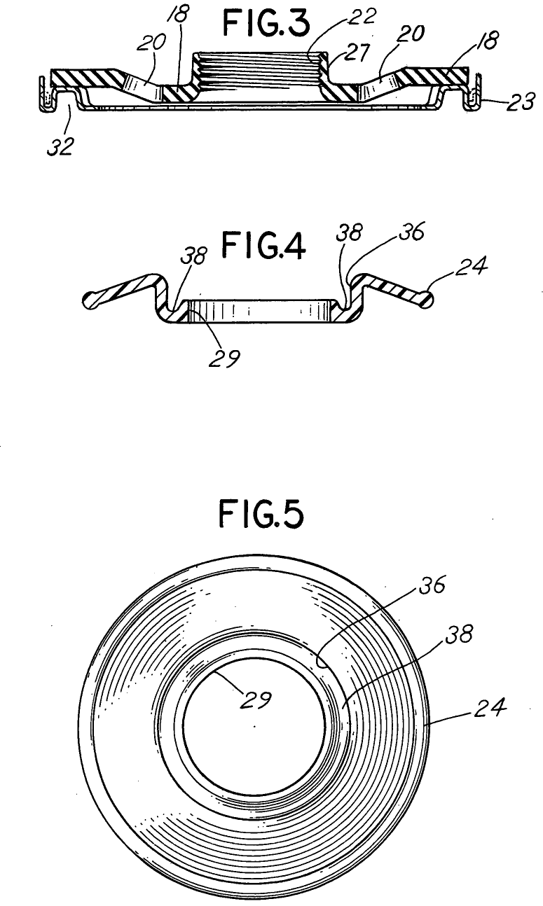

FIG. 2 shows the bottom view of the filter assembly 10. In the presently preferred embodiment of the invention, end plate 18 includes eight inlet openings 20. The end plate 18 also defines an outlet opening or openings 22 from which fluid flows out of the filter assembly 10. Opening configurations other than round are feasible and the number of openings can be varied to accommodate desired fluid flow, as will be apparent to persons skilled in the prior art, depending upon the application for the filter assembly 10.

FIG. 3 better shows the association of the end plate 18 and the lid 23 of the present invention. End plate 18 is suitably secured to the lid 23 by welding or other means. The recess 32 in lid 23 is adapted to receive and retain the gasket 25 in a force fit relationship. The lid 23 has projections 34 that slightly interfere with recess 32 so that in use, gasket 25 is forced into the recess 32 and retained in place by pressure from the projections 34 engaging and cooperating with the resilient gasket 25.

The resilient gasket 25 will be retained in the recess or groove 32 during handling of the filter assembly 10 and the projections 34 define cooperative engaging means for holding the gasket in place. Persons skilled in the art will understand that gasket 25 can be similarly retained in place in the recess 32 if the projections 34 on the lid 23 were eliminated and projections were provided on the outside or inside surfaces of the gasket 25 for engaging with the walls of recess 32. Such arrangement would function in an equivalent manner.

The first valve 24 is shown in FIGS. 4 and 5. The first valve 24 is annular and has opening 29 in the center of the valve to receive the raised portion of the end plate 18. Disposed radially outward from the central opening 29 is a raised portion 36. Raised portion 36 forms a shoulder 38 that receives the abutment 69 at the lower end of annular portion 67 of the end cap 66 when assembled.

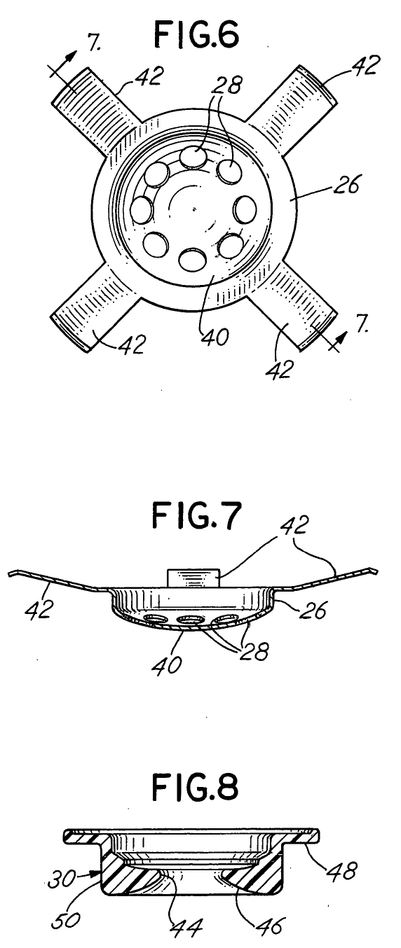

The spring 26 disposed between the annular filter media 14 and the housing 12 is better shown in FIGS. 6 and 7. The spring 26 bears against the top of the filter housing 12 (see FIG. 1) and biases the annular filter media 14 and core 16 towards the end plate 18. The spring 26 includes a central bowl-like portion 40 containing bypass openings 28. The spring 26 further includes four arm portions 42 that engage with the interior of housing 12 and apply a biasing force to the filter media 14. Persons skilled in the art will understand that the configurations and numbers of arm portions of spring 26 car be varied.

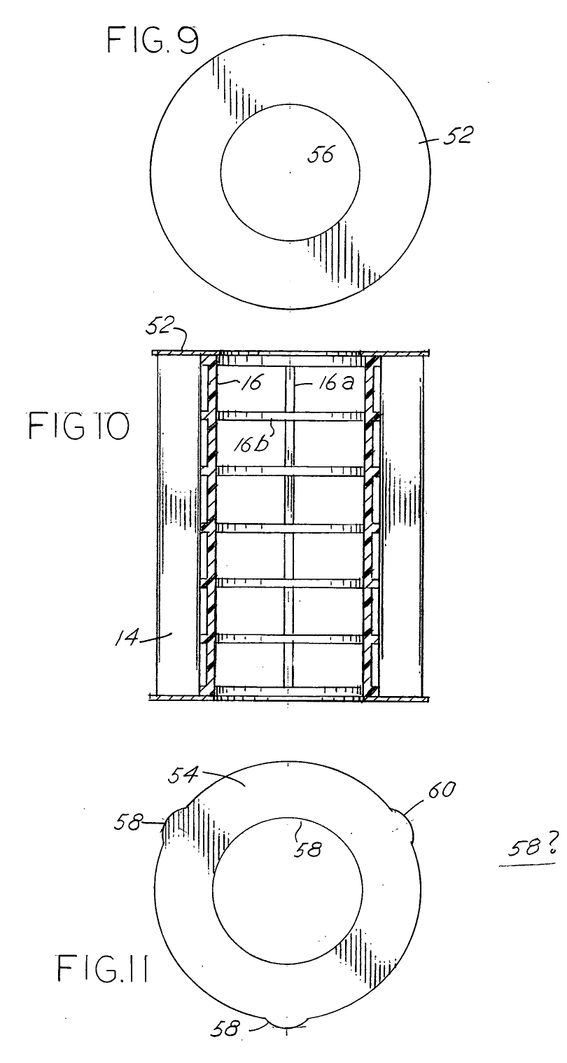

The bypass valve or second valve 30 is shown in FIG. 8. The second valve 30 is annular and includes a body with a generally cylindrical wall portion 50, with an outwardly extending annular lip 48 at one end and an inwardly extending annular flap 46 at the other end that contains a hole 44 in the center thereof. Annular lip 48 and consequently second valve 30 is held in place by spring 26 and annular filter media 14.

The material qualities of first valve 24 and second valve 30 are chosen such that first valve 24 is more resilient than the second valve 30. In this way, the first valve 24 will open under a lesser pressure, whereas the second valve 30 is stiffer and requires a higher pressure to open. In a presently preferred embodiment, the first valve 24 will open to permit fluid flow through the inlet openings 20 at a minimum pressure, for example on the order of 1 psi. By comparison, the second valve 30 will open to permit fluid flow through the bypass openings 28 at a higher predetermined pressure, for example on the order of 8-10 psi.

The assembly of the filter assembly 10 will now be described. The annular filter media 14 is positioned on the core 16 and the plastisol material 52 and 54 and the end caps 64 and 66 are positioned over the ends of the filter media and secured together in assembled relationship to form the filter media/core assembly. Top end cap enclosure 64 has an annular depending portion 65 for engaging the cylindrical wall portion 50 of second valve 30. The bottom end cap enclosure 66 likewise has an annular depending portion 67 that has an abutment 69 at the lower end as seen in FIG. 1 for abutting the shoulder 38 of the first valve 24 to firmly seat the first valve 24 against end plate 18.

The end plate 18 and the lid 23 are secured together, for example, by welding, and the gasket 25 is positioned and retained in the recess 32 of the lid. The spring 26 is first inserted into the open end of the housing 12 until it seats against the closed end of the housing 12. Second valve 30 is positioned in sealing engagement with the openings 28 in spring 26.

The filter media/core assembly is inserted into the housing 12 abutting the second valve 30. The top end cap enclosure 64 secures the top end of the filter media/core assembly and firmly seats the second valve 30 against the spring 26 to create a fluid-tight seal between the filter media/core assembly and the bypass valve or second valve 30. The anti-drain back or first valve 24 is positioned between the end cap 66 and the end plate 18, with the abutment 69 engaging the shoulder 38 to help seal fluid flow between the first valve 24 and the filter media/core assembly. The end plate 18 closes the open end of housing 12 and the outer rim of the lid 23 is rolled with the open end of the housing 12 to form a seal 62.

Positioning of the end plate 18 in the housing 12 partially compresses the spring 26, whereby, when the parts are assembled a biasing force is applied by the spring 26 to the top of the filter media/core assembly urging the filter media/core assembly towards the end plate 18. The spring force will help to pin the first valve 24 between the filter media/core assembly and the end plate 18 and to seal flow from between the filter media/core assembly and the end plate 18. The abutment 69 of the end cap 66 will firmly engage the shoulder 38 of the first valve 24. The top end cap 64 will firmly engage the second valve 30 to seal fluid flow between the upper end of the filter media/core assembly and the second valve 30. Stated somewhat differently, the biasing force of the spring 26 will pin the bypass valve 30 in sealing engagement between the spring 26 and the annular filter/media core assembly and will pin the anti-drain back valve 24 in sealing engagement between the filter media/core assembly and the end plate 18.

In operation, the filter assembly 10 is spun onto a threaded stud on the engine block which engages the threads in the outlet opening 22 in the end plate 18 and is secured in place. The flutes or recesses 13 in the housing 12 may be engaged by a tool to help to rotate the housing 12 firmly onto the threaded stud on the engine block in a conventional manner. The gasket 25 will engage the engine block and preclude fluid flow from between the engine block and the filter assembly 10. When the engine is started, fluid, usually oil, will enter the filter assembly 10 through inlet openings 20. Slight pressure will move the first valve 24 open from the inlet openings 20 and oil will flow through inlet openings 20, the filter media 14 and be discharged through the outlet opening means 22 for return to the engine. When the engine is turned off, the first valve 24 will close the inlet openings 20 and prevent return of oil in the filter assembly 10 to the engine. As the filter media 14 clogs during normal operation, pressure will build within the housing 12 of the filter assembly 10. Upon attainment of a predetermined pressure, the second valve 30 will flex downwardly as viewed in FIG. 1 to open and permit oil to flow through bypass openings 28 and back to the engine, thereby bypassing the filter media 14. Stated somewhat differently, during periods of time when high differential pressure exists across the filter media, such as due to cold thick oil or high contaminant loading of the filter media, the oil will go through the bypass openings 28 and open the second valve 30 to permit oil to bypass the filter media 14 and exit the filter assembly 10 through the outlet opening 22 for return to the engine.

The present invention reduces bypass valve complexity in applications where separate anti-drainback valves and bypass valves are employed in a filter. The bypass valve in the present invention is formed using one additional part. This permits a reduction of inventory of valve component parts, as one bypass valve can be used with a variety of different filter diameters.

In the preferred embodiment of the invention, most of the biasing force to retain the components in assembled relationship within the housing 12 is provided by the spring 26. Some biasing force would be supplied by the inherent resiliency of the anti-drain back valve 24 and the bypass valve 30. In an alternative embodiment, the spring 26 may be a retainer member that does not supply a biasing force and the biasing forces for urging the filter media/core assembly toward the end plate 18 and retaining the components within the housing engaged and in sealing relationship may be supplied by the resiliency of the anti-drain back valve 24 or the bypass valve 30 or the combined resiliency of the two valves 24 and 30. The resiliency may be varied by selection of the material of the two valves, as well as by varying the thickness of one or both of the two valves, as would be apparent to a person of ordinary skill in the art.

While a presently preferred embodiment of the present invention has been shown and described, it will be apparent to persons skilled in the art that the invention may be otherwise embodied within the scope of the following claims.

We claim:

1. A filter assembly comprising:
a housing open at one end,
an annular filter media/core assembly disposed in said housing,
an end plate secured to the open end of the housing, the end plate further having an inlet opening means and an outlet opening means,
a first valve disposed between the annular filter media/core assembly and the end plate for controlling fluid flow through the inlet opening means,
a spring disposed between a second end of the annular filter/media core assembly and the housing for biasing the annular filter media/core assembly towards the end plate, the spring further providing bypass opening means,
a second valve disposed between the annular filter media/core assembly and the spring for controlling fluid flow through the bypass opening means, the second valve having more resistance to fluid flow than the first valve,
whereby, in normal operation, the first valve will yield before the second valve and fluid flow will pass through the inlet opening means, the annular filter media/core assembly and then discharged through said outlet opening means, and
whereby when the annular filter media/core assembly begins to clog, fluid pressure will build and upon attainment of a predetermined pressure, the second valve will open the bypass opening means and permit fluid flow to bypass the annular filter media/core assembly flow, through the bypass opening means and out the outlet opening means.

2. The filter assembly of claim 1, wherein the first valve comprises an annular member with a central portion, the central portion engaging the annular filter media/core assembly to retain the valve in place.

3. The filter assembly of claim 1, wherein the second valve comprises an annular member retained in place between the annular filter media/core assembly and the spring.

4. The filter assembly of claim 2, wherein the annular filter media/core assembly includes a central core surrounded by filter media and a pair of end caps, with one of the end caps having an annular projection portion that engages the first valve.

5. The filter assembly of claim 4, wherein the first valve includes a shoulder portion and the annular projection portion of said one of the end caps engages the shoulder portion of the first valve.

6. The filter assembly of claim 1, wherein the inlet opening means comprises a plurality of discrete openings.

7. The filter assembly of claim 1, wherein the inlet opening means comprises a plurality of openings arranged generally concentrically around the axis of the filter media/core assembly.

8. The filter assembly of claim 1, wherein the bypass opening means comprises a plurality of discrete openings.

9. The filter assembly of claim 1, wherein the bypass opening means comprises a plurality of openings arranged generally concentrically around the axis of the filter media/core assembly.

10. The filter assembly as in claim 9, wherein the second valve cooperates with the plurality of openings to control fluid flow through said plurality of openings.

11. The filter assembly of claim 1, wherein the annular filter media/core assembly comprises a core, a filter media surrounding the core and end caps at the ends of the filter media, the filter media and end caps being fabricated from materials that can be bonded to fuse the components to one another and preclude significant fluid flow therebetween.

12. The filter assembly of claim 1, further comprising a lid secured to the end plate, the lid having an outwardly extending recess for receiving a gasket.

13. The filter assembly of claim 12, further comprising complementary retaining means between the gasket and the sides of the recess for retaining the gasket in the recess.

14. The filter assembly of claim 1, wherein the complementary retaining means includes projections on either the gasket or a wall of the recess, wherein the gasket is retained in the recess when the gasket is inserted into the recess.

15. The filter assembly as in claim 1, wherein the spring has a central portion with said bypass opening means therein, and a plurality of arms extending outwardly from the central portion; the arms engaging the interior of the housing for biasing the annular filter media/core assembly towards the end plate.

16. The filter assembly as in claim 15, wherein the outer surface of the central portion of the spring is complementary to an inner surface of the second valve and engages within the second valve.

17. The filter assembly as in claim 1, wherein the annular filter media/core assembly includes an upper and a lower end cap, the upper end cap engaging the second valve and the lower end cap engaging the first valve.

18. The filter assembly as in claim 17, wherein the end plate has a central portion defining the outlet opening means, the first valve having a central opening that receives the central portion of the end plate, and an annular shoulder adjacent the central opening, the lower end cap having a downwardly extending annular portion that engages with the annular shoulder

19. A filter assembly comprising:
a housing open at one end;
an annular filter media/core assembly disposed in the housing;
an end plate secured to the open end of the housing, the end plate having inlet opening means and outlet opening means,
a first resilient valve disposed between one end of the annular filter media/core assembly and the end plate for controlling fluid flow through the inlet opening means;
retainer means disposed between the second end of the filter media/core assembly and the housing, the retainer providing bypass opening means;
a second resilient valve disposed between the annular filter media/core assembly and the retainer means for controlling fluid flow through the bypass opening means, the second valve having more resistance to fluid flow than the first valve;
the resiliency of the first valve and the resiliency of the second valve providing the biasing forces to maintain the retainer, second valve, annular filter media/core assembly, first valve and end plate in assembled and sealing relationship in the housing;
whereby, in normal operation, the first valve will yield before the second valve and fluid flow will pass through the inlet opening means, the annular filter media/core assembly and discharged through the outlet opening means, and whereby, when the annular filter media/core assembly begins to clog, fluid pressure will build and upon attainment of a predetermined pressure, the second valve will open the bypass opening means and permit fluid flow to bypass the annular filter media/core assembly, flow through the bypass opening means and out the outlet opening means.

20. A method for assembling a filter assembly comprising the steps of:
positioning within a filter housing open at one end a spring retainer comprising bypass opening means and a resilient bypass valve in engagement with the bypass opening means;
inserting an annular filter media/core assembly to engage the bypass valve;
positioning a resilient anti-drainback valve adjacent to the annular filter media/core assembly; and
securing an end plate to the open end of the filter housing;
whereby, the biasing force of the resilient bypass valve and the resilient anti-drainback valve spring pins the bypass valve in sealing engagement between the retainer and the annular filter media/core assembly and pins the anti-drainback valve in sealing engagement between the annular filter media/core assembly and the end plate.

21. The method of claim 21, wherein the retainer comprises a spring, said spring applying a biasing force to pin the bypass valve in sealing engagement between the spring and the annular filter media/core assembly and pins the anti-drainback valve in sealing engagement between the annular filter media/core assembly and the end plate.
